(19) United States
(12) Patent Application Publication
(10) Pub. No.: US 2019/0166280 A1
(43) Pub. Date: May 30, 2019

(54) IMAGE READING APPARATUS

(71) Applicant: SEIKO EPSON CORPORATION, Tokyo (JP)

(72) Inventors: Kazutoshi NISHIDA, Kitakyushu-shi (JP); Kazuya YOSHIKAIE, Kitakyushu-shi (JP)

(21) Appl. No.: 16/199,836

(22) Filed: Nov. 26, 2018

(30) Foreign Application Priority Data
Nov. 29, 2017 (JP) 2017-228727

(51) Int. Cl. H04N 1/203; H04N 1/00

(52) U.S. Cl. CPC H04N 1/203; H04N 1/00681

(57) ABSTRACT

Disclosed is a scanner including a first reading unit that reads a first surface of paper and a second reading unit that reads a second surface, in which a control unit suppresses an amount of light emitted from a second downstream side light source below an amount of light emitted at the time of reading by the second reading unit until a leading end of the paper being transported is transported to a first position where the light emitted from the second downstream side light source of the second reading unit may be blocked from entering a first reading region, and when the leading end of the paper passes the first position, sets the amount of light emitted from the second downstream side light source to the amount of light emitted at the time of reading by the second reading unit.

### BACKGROUND

### 1. Technical Field

The present invention relates to an image reading apparatus which reads an image on a document.

### 2. Related Art

A scanner as an example of an image reading apparatus has an automatic transporting device (also referred to as an auto document feeder (ADF)) that sends a document to a reading unit, and is configured to be able to perform automatic transporting and reading of a plurality of pieces of the document.

In addition, in such a scanner, in order to read both sides of the document with a single transporting, a first reading unit provided on one side of a path surface constituting a transport path, and a second reading unit provided on the other side of the path surface may be provided (for example, JP-A-2002-111977).

For the reading unit, a CIS (contact type image sensor) system that reads reflected light by irradiating a document with light and a reduction optical (CCD image sensor) system or the like is used.

By the way, if the first reading unit and the second reading unit are provided so as to completely face to each other, there is a concern that the light emitted from the light source of one reading unit may affect the reading of the image by the other reading unit. Therefore, the first reading unit and the second reading unit are arranged to be shifted slightly apart from each other in the transport direction of the document.

If the first reading unit and the second reading unit are provided at positions apart from each other in the transport direction, the influence on reading by the other reading unit by the light of the light source of one reading unit is reduced, however, the length of the transport path becomes longer, and the apparatus becomes larger.

Therefore, it is desirable to provide the first reading unit and the second reading unit at positions as close as possible while shifting them apart in the transport direction.

However, since the light emitted from the light source of one reading unit reflects on the path surface (usually formed of a material such as glass that can transmit light) of the other reading unit side, considering the influence of this reflected light, there is a limit to bringing the first reading unit and the second reading unit closer to each other.

In order to avoid these problems, in JP-A-2002-111977, the first reading unit and the second reading unit are arranged to be shifted apart from each other in the transport direction, and the light source of the first reading unit and the light source of the second reading unit are controlled so as to be turned on immediately before image reading is started and turned off immediately after image reading is stopped, respectively.

By this, while arranging the first reading unit and the second reading unit closer to each other, the concern that the light of the light source of the reading unit on one side affects the reading by the reading unit on the other side is relieved.

Here, when the light source is changed from the non-light-on state to the light-on state, the amount of light may not be stabilized for a certain period of time after turn-on.

As described in JP-A-2002-111977, when the light source of the reading unit is turned on immediately before image reading is started, there is a concern that the reading accuracy is lowered for the duration of time when the amount of light from the light source described above is unstable.

### SUMMARY

An advantage of some aspects of the invention is to provide an image reading apparatus which takes into consideration both appropriate reading of an image by the reading unit and prevention of increasing size of the apparatus.

According to an aspect of the invention, there is provided an image reading apparatus including: a transport path on which a medium is transported; a first transmission plate that has light transmitting property and forms a path surface on one side of the transport path; a second transmission plate that has the light transmitting property and forms a path surface on the other side of the transport path facing the first transmission plate; a first reading unit that includes a first upstream side light source which emits light from an upstream side in a medium transport direction to a first reading region of the transport path and a first downstream side light source which emits light from a downstream side in the medium transport direction to the first reading region, and reads an image on a first surface of the medium in the first reading region through the first transmission plate; a second reading unit that includes a second upstream side light source which emits light from the upstream side in the medium transport direction to a second reading region positioned on a further downstream side of the first reading region of the transport path in the medium transport direction and a second downstream side light source which emits light from the downstream side in the medium transport direction to the second reading region, and reads an image on a second surface of the medium which is a surface opposite to the first surface in the second reading region through the second transmission plate; and a control unit that controls an amount of the light emitted from the first upstream side light source, the first downstream side light source, the second upstream side light source, and the second downstream side light source, in which the first transmission plate and the second transmission plate are provided at a position overlapping with both the first reading unit and the second reading unit, in the medium transport direction, and in which the control unit suppresses the amount of light emitted from the second downstream side light source below the amount of light emitted at the time of reading by the second reading unit until a leading end of the medium being transported is transported to a first position where the light emitted from the second downstream side light source is blocked from entering the first reading region, on an upstream side of the second reading region in the medium transport direction, and when the leading end of the medium passes the first position, sets the amount of light emitted from the second downstream side light source to an amount of light emitted at the time of reading by the second reading unit.

In the present specification, “reducing the amount of light” includes the case where the amount of light is zero, that is, the case where the light is turned off. In addition, “light emitted from the light source” includes a reflected light reflected by the emitted light other than emitted light which is emitted from light source, and may be any of the emitted light or the reflected light.

With this configuration, the control unit suppresses the amount of light emitted from the second downstream side light source below the amount of light emitted at the time of reading by the second reading unit until a leading end of the medium being transported is transported to a first position where the light emitted from the second downstream side light source is blocked from entering the first reading region, on the upstream side of the second reading region in the medium transport direction, thereby relieving the concern that the light emitted from the second downstream side light source affects the reading by the first reading unit.

In addition, when the light is intensified from the weakened state by reducing the amount of light, the amount of light may become unstable for a short time, however, with this configuration, only the amount of light that is likely to affect the reading by the first reading unit (the second downstream side light source) among the two light sources (second upstream side light source and second downstream side light source) in the second reading unit is reduced, thereby reducing the concern that a state where the amount of light is unstable immediately after intensifying light affects at the time of reading by the second reading unit.

The control unit may suppress the amount of light emitted from the first upstream side light source below the amount of light emitted at the time of reading by the first reading unit on an upstream side of the second reading region in the medium transport direction, when a trailing end of the medium being transported passes a second position where the light emitted from the first upstream side light source may be blocked from entering the second reading region.

With this configuration, the control unit suppresses the amount of light emitted from the first upstream side light source below the amount of light emitted at the time of reading by the first reading unit on the upstream side of the second reading region in the medium transport direction, when the trailing end of the medium being transported passes the second position where the light emitted from the first upstream side light source may be blocked from entering the second reading region, thereby reducing the concern that the light emitted from the first upstream side light source affects the reading by the second reading unit.

According to another aspect of the invention, there is provided an image reading apparatus including: a transport path on which a medium is transported; a first transmission plate that has light transmitting property and forms a path surface on one side of the transport path; a second transmission plate that has light transmitting property and forms a path surface on the other side of the transport path facing the first transmission plate; a first reading unit that includes a first upstream side light source which emits light from an upstream side in a medium transport direction to the first reading region of the transport path and a first downstream side light source which emits light from the downstream side in a medium transport direction to the first reading region, and reads an image on the first surface of the medium in the first reading region through the first transmission plate; and a second reading unit that includes a second upstream side light source which emits light from the upstream side in the medium transport direction to a second reading region positioned on the downstream side of the first reading region of the transport path in the medium transport direction and a second downstream side light source which emits light from the downstream side in the medium transport direction to the second reading region and reads an image on a second surface which is a surface opposite to the first surface of a medium in the second reading region through the second transmission plate, in which the first transmission plate and the second transmission plate are provided at a position overlapping with both the first reading unit and the second reading unit, in the medium transport direction, in which the apparatus further includes a first shutter portion capable of switching between a blocked state in which light emitted from the first upstream side light source to the first reading region is blocked, and an opened state in which the light emitted from the first upstream side light source reaches the first reading region; a second shutter portion capable of switching between a blocked state in which light emitted from the second downstream side light source to the second reading region is blocked, and an opened state in which the light emitted from the second downstream side light source reaches the second reading region; and a control unit which controls switching between the blocked state and the opened state of the first shutter portion and the second shutter portion, and in which the control unit sets the second shutter portion as the blocked state until the leading end of the medium being transported is transported to the first position where the light emitted from the second downstream side light source is blocked from entering the first reading region, on an upstream side of the second reading region in the medium transport direction, and when the leading end of the medium passes the first position, sets the second shutter portion to the opened state.

With this configuration, since the control unit sets the second shutter portion as the blocked state until the leading end of the medium being transported is transported to the first position where the light emitted from the second downstream side light source is blocked from entering the first reading region, on the upstream side of the second reading region in the medium transport direction, and when the leading end of the medium passes the first position, sets the second shutter portion to the opened state, it is possible to relieve the concern that the light emitted from the second downstream side light source affects the reading by the first reading unit.

In addition, when the amount of light from the light source is reduced and then the amount of light is returned to the state before reducing, the amount of light may not be stabilized for a short time after returning, however, with this configuration, there is no need to reduce the amount of light, thus it is possible to relieve the concern that the amount of light emitted from the light source becomes unstable.

The control unit may set the first shutter portion as the blocked state when the trailing end of the medium being transported passes the second position where the light emitted from the first upstream side light source is blocked from entering the second reading region, on the upstream side of the second reading region in the medium transport direction.

With this configuration, the control unit sets the first shutter portion as the blocked state when the trailing end of the medium being transported passes the second position where the light emitted from the first upstream side light source is blocked from entering the second reading region, on the upstream side of the second reading region in the medium transport direction, thereby reducing the concern that the light emitted from the first upstream side light source affects the reading by the second reading unit.

According to still another aspect of the invention, there is provided an image reading apparatus including: a transport path on which a medium is transported; a first transmission plate that has light transmitting property and forms a path surface on one side of the transport path; a second transmission plate that has the light transmitting property and forms a path surface on the other side of the transport path facing the first transmission plate; a first reading unit that includes a first upstream side light source which emits light from the upstream side in the medium transport direction to the first reading region of the transport path and a first downstream side light source which emits the light from the downstream side in the medium transport direction to the first reading region, and reads an image on a first surface of the medium in the first reading region through the first transmission plate; and a second reading unit that includes a second upstream side light source which emits the light from the upstream side in the medium transport direction to the second reading region positioned on the downstream side of the first reading region of the transport path in the medium transport direction and a second downstream side light source which emits the light from the downstream side in the medium transport direction to the second reading region, and reads an image on a second surface which is a surface opposite to the first surface of the medium, in the second reading region through the second transmission plate, in which the first transmission plate and the second transmission plate are provided at a position overlapping with a position overlapping with both the first reading unit and the second reading unit, in the medium transport direction, the first transmission plate includes a first reflection suppression unit which suppresses reflection of light emitted from the second downstream side light source, and the second transmission plate includes a second reflection suppression unit which suppresses reflection of the light emitted from the first upstream side light source.

With this configuration, the first transmission plate includes a first reflection suppression unit which suppresses reflection of light emitted from the second downstream side light source, thereby reducing the concern that the reflected light of the light emitted from the second downstream side light source affects the reading by the first reading unit.

In addition, the second transmission plate includes a second reflection suppression unit which suppresses reflection of the light emitted from the first upstream side light source, thereby reducing the concern that the reflected light of the light emitted from the first upstream side light source affects the reading by the second reading unit.

The first reflection suppression unit or the second reflection suppression unit may be a seam when two transmission plates constituting each of the first transmission plate or the second transmission plate are connected side by side in the medium transport direction.

With this configuration, the first reflection suppression unit or the second reflection suppression unit can be formed in a simple configuration.

A blocking plate which suppresses the transmission of light may be interposed in the seam.

With this configuration, in the first reflection suppression unit or the second reflection suppression unit, reflection of light may be suppressed more reliably.

A paint that reduces light transmitting property may be applied on the seam.

With this configuration, the reflection of light may be suppressed more reliably in the first reflection suppression unit or the second reflection suppression unit.

The two transmission plates constituting each of the first transmission plate or the second transmission plate may have different refractive indices.

With this configuration, the two transmission plates constituting each of the first transmission plate or the second transmission plate may have different refractive indices, thereby suppressing the reflection of light more reliably at the seam as the first reflection suppression unit or the second reflection suppression unit.

The first reflection suppression unit or the second reflection suppression unit may be formed on the first transmission plate or the second transmission plate by a laser engraving.

With this configuration, since the first reflection suppression unit or the second reflection suppression unit is formed in the first transmission plate or the second transmission plate by the laser engraving, the reflection suppression unit can be formed without dividing the transmission plate into two.

The seam may be inclined with respect to a surface of the first transmission plate or the second transmission plate when viewed from a width direction intersecting the medium transport direction.

With this configuration, the sectional area of the first reflection suppression unit or the second reflection suppression unit can be increased, thereby suppressing the reflection of light more reliably.

### BRIEF DESCRIPTION OF THE DRAWINGS

The invention will be described with reference to the accompanying drawings, wherein like numbers reference like elements.

FIG. 1 is an external perspective view illustrating a scanner according to a first embodiment.

FIG. 2 is a side corss-sectional view illustrating a paper transport path in the scanner according to the first embodiment.

FIG. 3 is a schematic cross-sectional side view illustrating a periphery of an image reading unit in the scanner according to the first embodiment.

FIG. 4 is a view illustrating a state where paper is being read by both a first reading unit and a second reading unit.

FIG. 5 is a view illustrating a state where the leading end of paper is positioned in the first reading region of a first reading unit.

FIG. 6 is a view for explaining controlling of an amount of light of a light source by a control unit.

FIG. 7 is a view for explaining controlling of the amount of light of the light source by the control unit.

FIG. 8 is a view illustrating a state where the trailing end of the paper is positioned in the second reading region of the second reading unit.

FIG. 9 is a view for explaining controlling of the amount of light of the light source by the control unit.

FIG. 10 is a view for explaining controlling of the amount of light of the light source by the control unit.

FIG. 11 is a view illustrating an opened state of a first shutter portion and a second shutter portion according to a second embodiment.

FIG. 12 is a view illustrating a blocked state of the first shutter portion and the second shutter portion according to the second embodiment.

FIG. 13 is a view for explaining controlling of the first shutter portion and the second shutter portion by the control unit.

FIG. 14 is a view for explaining controlling of the first shutter portion and the second shutter portion by the control unit.

FIG. 15 is a view for explaining controlling of the first shutter portion and the second shutter portion by the control unit.

FIG. 16 is a view for explaining controlling of the first shutter portion and the second shutter portion by the control unit.

FIG. 17 is a schematic cross-sectional side view illustrating a periphery of the image reading unit in the scanner according to the third embodiment.

FIG. 18 is a view for explaining Modification Example 1 of the third embodiment.

FIG. 19 is a view for explaining Modification Example 2 of the third embodiment.

FIG. 20 is a view for explaining Modification Example 3 of the third embodiment.

FIG. 21 is a schematic side view illustrating a first transmission plate and a second transmission plate of an image reading unit according to a fourth embodiment.

FIG. 22 is a view for explaining another example of the first transmission plate and the second transmission plate.

### DESCRIPTION OF EXEMPLARY EMBODIMENTS

### First Embodiment

First, an outline of an image reading apparatus according to one embodiment of this invention will be described.

In this embodiment, as an example of an image reading apparatus, a document scanner (hereinafter, simply referred to as scanner 1) capable of reading at least one of a front surface and a back surface of paper as a “medium” is taken as an example.

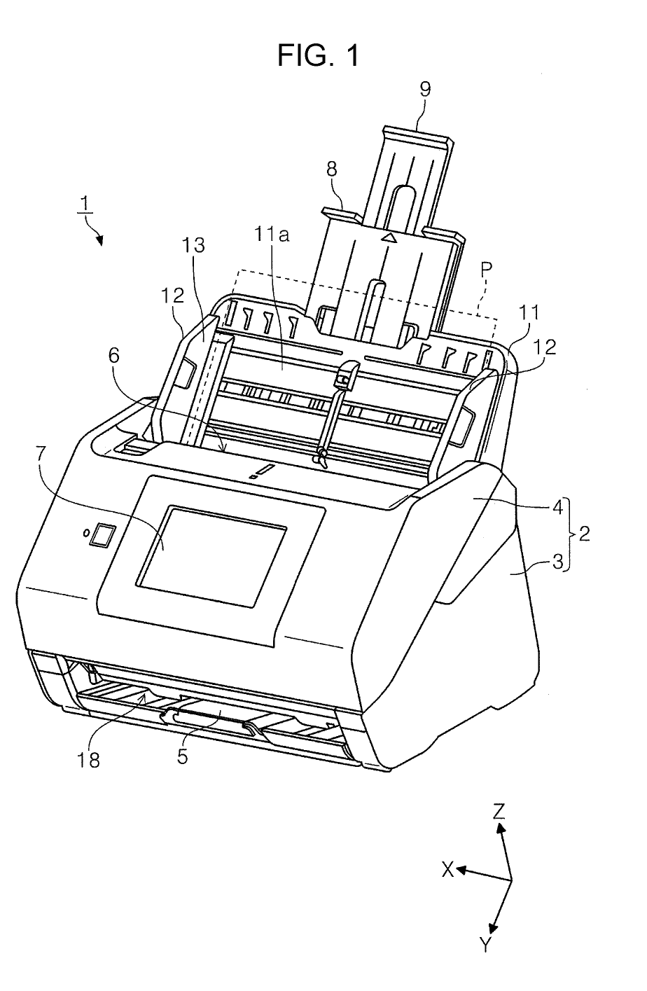

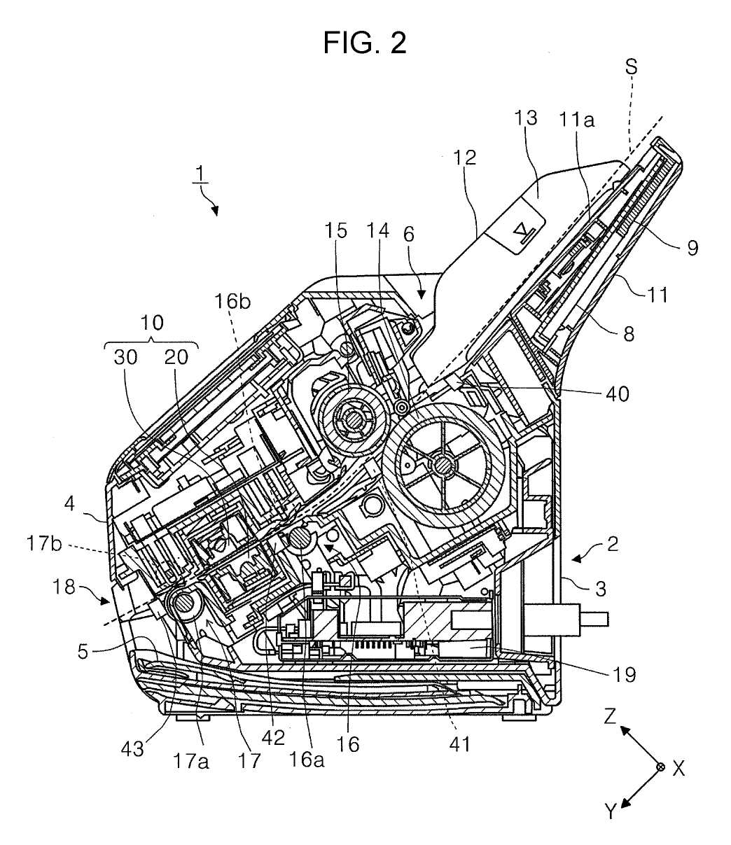

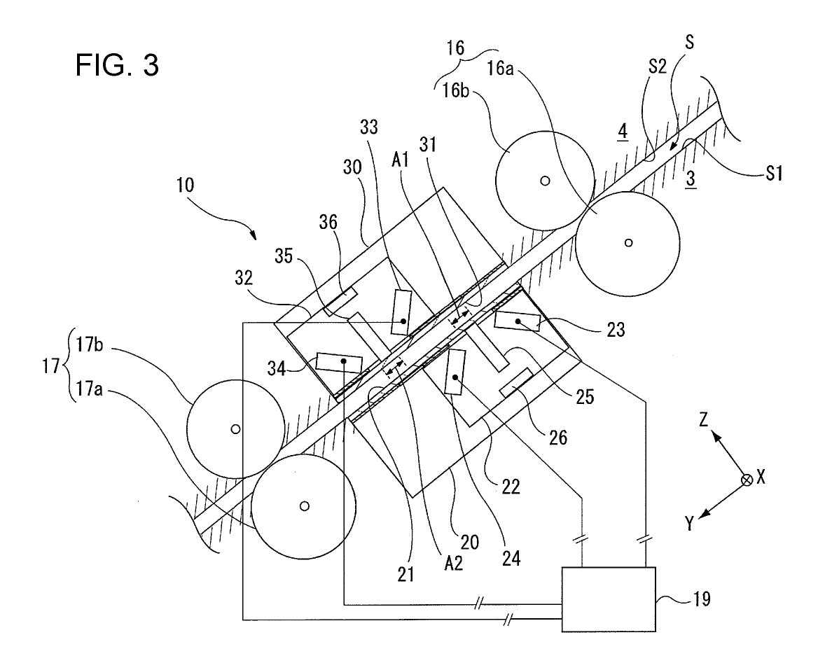

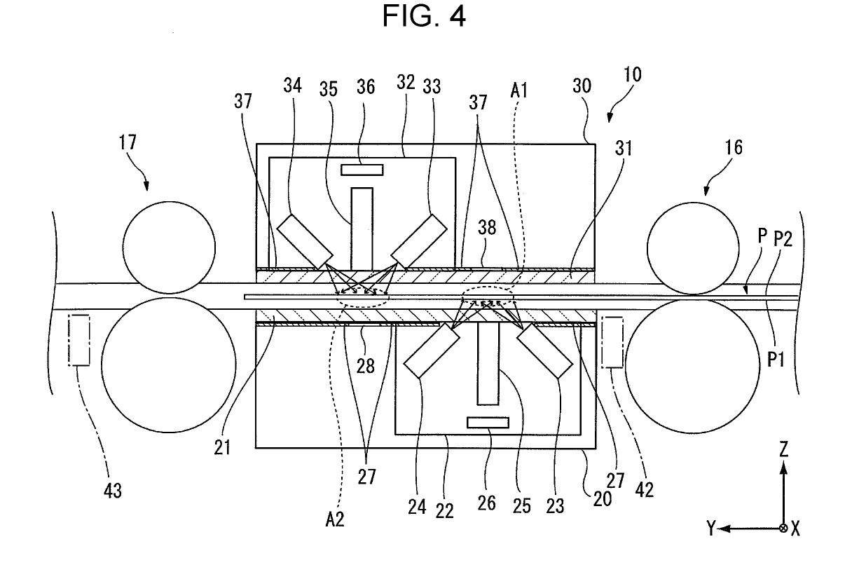

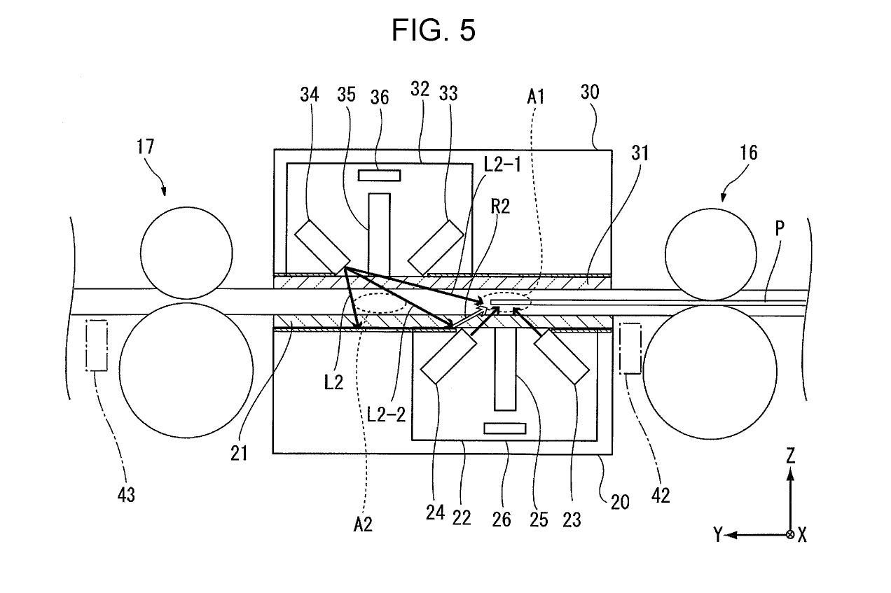

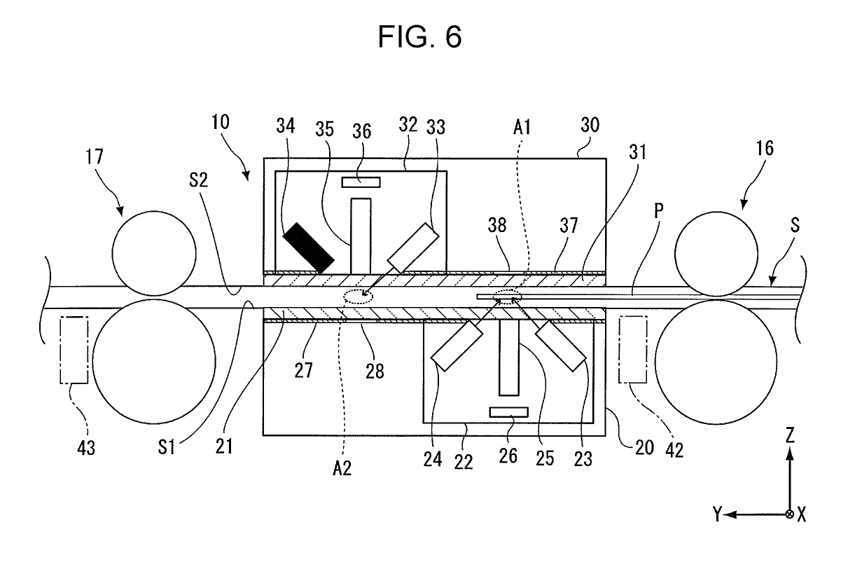

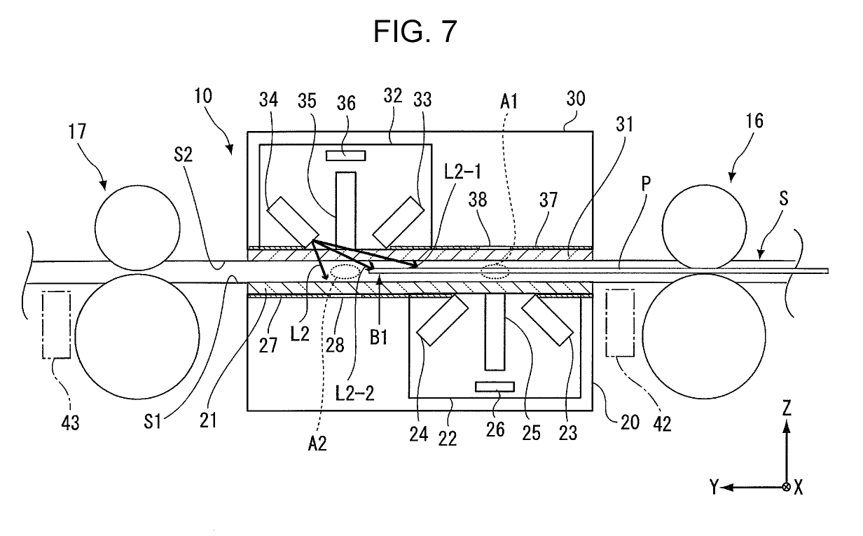

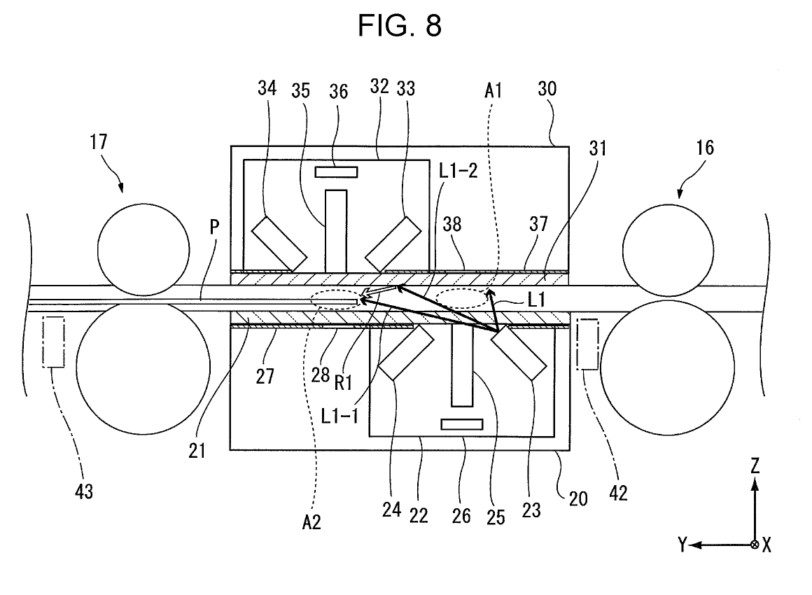

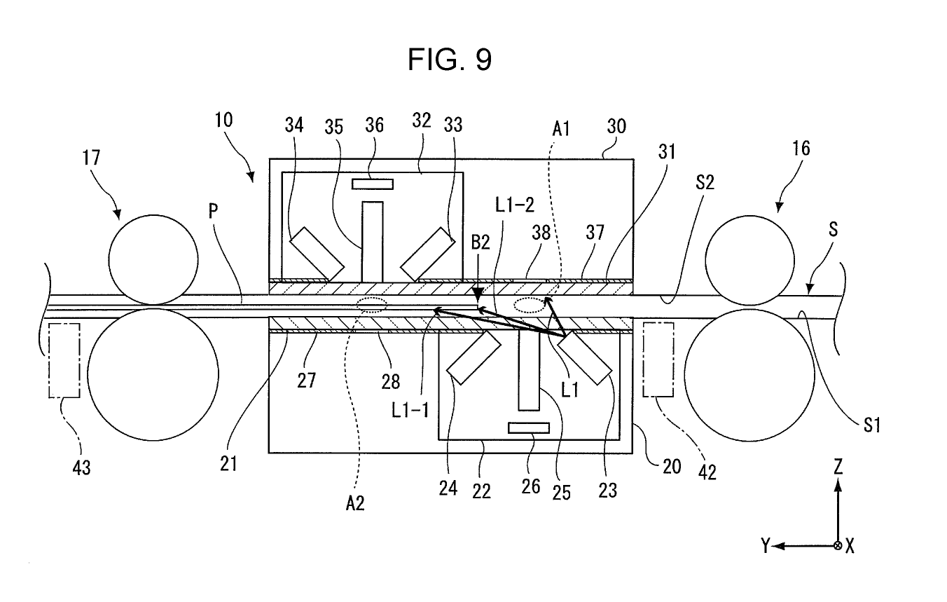

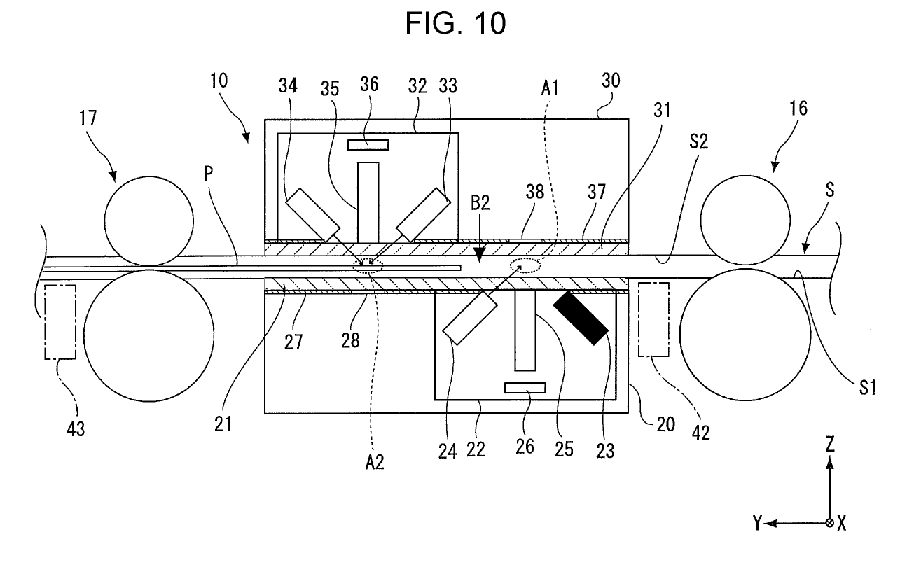

FIG. 1 is an external perspective view illustrating a scanner according to a first embodiment. FIG. 2 is a side corss-sectional view illustrating a paper transport path in the scanner according to the first embodiment. FIG. 3 is a schematic side cross-sectional view illustrating a periphery of the image reading unit in the scanner according to the first embodiment. FIG. 4 is a view illustrating a state where paper is being read by both the first reading unit and the second reading unit. FIG. 5 is a view illustrating a state where a leading end of paper is positioned in a first reading region of the first reading unit. FIG. 6 is a view for explaining controlling of an amount of light of a light source by the control unit. FIG. 7 is a view for explaining the controlling of the amount of light of the light source by the control unit. FIG. 8 is a view illustrating a state where a trailing end of the paper is positioned in a second reading region of the second reading unit. FIG. 9 is a view for explaining the controlling of the amount of light of the light source by the control unit. FIG. 10 is a view for explaining the controlling of the amount of light of the light source by the control unit.

In the X-Y-Z coordinate system shown in each figure, the X denotes an apparatus width direction and the paper width direction, and the Y denotes a paper transport direction. The Z denotes a direction intersecting with the Y direction and generally shows the direction orthogonal to a surface of paper that is transported. In addition, the +Y direction side denotes a front surface of the apparatus, and the −Y direction side denotes a rear surface side of the apparatus. In addition, when viewed from the front surface of the apparatus, the left side denotes a +X direction and the right side denotes a −X direction. In addition, the +Z direction is defined as an upper portion (including an upper portion, an upper surface, or the like) of the apparatus, and the −Z direction side is defined as a lower portion (including a lower portion, a lower surface, or the like) of the apparatus. In addition, the direction (+Y direction side) in which paper P is transported is referred to as “downstream”, and the direction (−Y direction side) opposite to the +Y direction side is referred to as “upstream”.

### Overview of Scanner

Hereinafter, the scanner 1 according to the invention will be described mainly with reference to FIGS. 1 and 2.

The scanner 1 shown in FIG. 1 includes an apparatus main body 2 including therein an image reading unit 10 (FIG. 2) which reads an image on a paper P (medium).

The apparatus main body 2 includes a lower portion unit 3 and an upper portion unit 4. The upper portion unit 4 is attached to the lower portion unit 3 so as to be openable and closable about the downstream side in the paper transport direction as a pivot point, and is configured to pivotally open the upper portion unit 4 to the front surface of the apparatus to expose the paper transport path of the paper P to facilitate handling of the paper jam of the paper P.

A medium placement portion 11 accomodating the paper P placed therein is provided on the back surface side (−Y axis direction side) of the apparatus main body 2. A paper bundle on which a plurality of sheets of paper P are stacked may be placed on the medium placement portion 11. In addition, it is also possible to place a booklet containing a plurality of sheets of paper in a form of a book as a document. Reference numeral 11a denotes a placement surface 11a for the paper P.

Further, the medium placement portion 11 is provided detachably with respect to the apparatus main body 2.

A pair of left and right edge guides 12 and 12 that have a guide face 13 that guides a side edge of the paper P in a width direction (X axis direction) intersecting the transport direction (Y axis direction) is provided in the medium placement portion 11.

The edge guides 12, 12 are provided to be moved slidably in the X axis direction according to the size of the paper P. In the present embodiment, the edge guides 12, 12 are configured such that one edge guide 12 follow the X movement (for example, +X side) and the other edge guide 12 moves in the opposite direction (−X side), by a known rack and pinion mechanism.

That is, the paper P is aligned in the center of the medium placement portion 11 in the width direction with the feeding roller 14 described below being provided in the central region in the width direction, and is configured to be transported by the so-called center paper transporting manner.

The medium placement portion 11 includes a first auxiliary paper support 8 and a second auxiliary paper support 9. As shown in FIG. 2, the first auxiliary paper support 8 and the second auxiliary paper support 9 may be housed inside the medium placement portion 11, and as shown in FIG. 1, are configured so that they can be pulled out from the medium placement portion 11, and as a result, the length of the placement surface 11a can be adjusted.

As shown in FIG. 1, the apparatus front surface of the upper portion unit 4 is provided with an operation panel 7 for displaying various reading settings, read execution operations, reading setting contents or the like.

A transporting port 6 leading to the inside of the apparatus main body 2 is provided at an upper portion of the upper portion unit 4, and paper P placed on the medium placement portion 11 is sent from the transporting port 6 to the image reading unit 10 (FIG. 2) provided inside the apparatus main body 2.

In addition, a discharge paper tray 5 described below is provided on the apparatus front surface of the lower portion unit 3.

### Paper Transport Path in the Scanner

Next, the paper transport path in the scanner 1 will be described with reference to FIGS. 2 and 3. In FIG. 2, a dotted line indicated by reference symbol S indicates a transport path along which the paper P (FIG. 1) is transported. As shown in FIG. 3, the transport path S is a space sandwiched by a path surface S1 on the lower portion unit 3 side and a path surface S2 on the upper portion unit 4 side.

In the scanner 1 shown in FIG. 2, paper P is transported from the medium placement portion 11 to the image reading unit 10 by a feeding roller 14 described below.

The scanner 1 has a feeding roller 14 that transports paper P, and a separation roller 15 that nips paper P with the feeding roller 14 and rotates in a direction opposite (counterclockwise rotation in a plan view of FIG. 2) to the paper P transporting direction to separate the paper P. As described above, the scanner 1 is configured to transport the paper in the center paper transporting manner, and the feeding roller 14 and the separation roller 15 are provided in the central region in the medium width direction (X axis direction) intersecting the medium transport direction (+Y direction). In addition, the feeding roller 14 and the separation roller 15 are driven by driving source not shown.

A first transport roller pair 16 and a second transport roller pair 17, that transport the paper P transported by the feeding roller 14 are provided on the downstream side of the feeding roller 14.

An image reading unit 10 is provided between the first transport roller pair 16 and the second transport roller pair 17.

In FIG. 2, the paper P placed on the medium placement portion 11 is picked up by the feeding roller 14 rotatably provided with respect to the lower portion unit 3 and transported to the downstream side (the +Y direction side). More specifically, the feeding roller 14 rotates while contacting the surface of the paper P facing the medium placement portion 11, to transport the paper P to the downstream side. Therefore, when a plurality of sheets of paper P are set in the medium placement portion 11 in the scanner 1, paper is transported first from the sheets of paper P on the placement surface 11a side sequentially to the downstream side.

The first transport roller pair 16 is provided on the upstream side of the image reading unit 10 and transports the paper P transported by the feeding roller 14 to the image reading unit 10. The first transport roller pair 16 includes a first driving roller 16a driven by not-shown driving source and a first driven roller 16b rotately driven by the rotation of the first driving roller 16a.

Like the feeding roller 14, the first transport roller pair 16 is also provided in the central region in the medium width direction.

The image reading unit 10 includes a lower side reading unit 20 provided on the lower portion unit 3 side and an upper side reading unit 30 provided on the upper portion unit 4 side.

The lower side reading unit 20 reads “first surface (surface facing the lower side, which hereinafter may be referred to as the back surface)” of the paper P, and the upper side reading unit 30 reads “second surface (surface facing the upper side, hereinafter may be referred to as the front face)” which is the surface opposite to the “first surface” of the paper P.

As shown in FIG. 3, the lower side reading unit 20 has light transmitting property and includes a first transmission plate 21 forming a path surface S1 on one side of the transport path S. The first transmission plate 21 and the path surface S1 are flush with each other. In addition, the upper side reading unit 30 has the light transmitting property and includes a second transmission plate 31 forming a path surface S2 on the other side of the transport path S facing the first transmission plate 21. The second transmission plate 31 and the path surface S2 are flush with each other.

The lower side reading unit 20 includes a first reading unit 22 which reads an image on the first surface of paper P. The upper side reading unit 30 includes a second reading unit 32 which reads an image on the second surface of the paper P. The configuration of the first reading unit 22 and the second reading unit 32 will be described in more detail below.

After the image on at least one of the first surface and the second surface of paper P is read by the image reading unit 10, the paper P is nipped by the second transport roller pair 17 positioned on the downstream side of image reading unit 10 and discharged from the discharge port 18 provided in the apparatus front surface of the lower portion unit 3. The second transport roller pair 17 includes a second driving roller 17a driven by a driving source not shown and a second driven roller 17b rotatably driven by the rotation of the second driving roller 17a.

The lower portion unit 3 is provided with a discharge paper tray 5 configured to be capable of being withdrawn from a discharge port 18 to the apparatus front surface. The discharge paper tray 5 may be in the state of being housed in the bottom portion of the lower portion unit 3 (FIG. 1) or the state pulled out to the apparatus front surface, which is not shown. With the discharge paper tray 5 withdrawn, the paper P discharged from the discharge port 18 may be loaded on the discharge paper tray 5.

As shown in FIG. 2, in the paper placement region of the medium placement portion 11 which is the upstream side of the feeding roller 14, a first detecting unit 40 that detects the absence or presence of a paper P placed on the medium placement portion 11 is provided. On the downstream side of the feeding roller 14, the downstream side of the first transport roller pair 16 and the downstream side of the second transport roller pair 17, a second detecting unit 41, a third detecting unit 42, and a fourth detecting unit 43 are provided sequentially. The leading end position of paper P in the medium transport direction may be detected by the second detecting unit 41, the third detecting unit 42, and fourth detecting unit 43.

In the present embodiment, the first detecting unit 40, the second detecting unit 41, the third detecting unit 42, and the fourth detecting unit 43 are provided in the central region in the width direction.

For the first detecting unit 40, the second detecting unit 41, the third detecting unit 42, and the fourth detecting unit 43, light sensor that has light emitting portion (not shown) that emits light and light receiving portion that receives the reflected light of the light emitted from the light emitting portion may be used. In addition to the light sensor, it is also possible to use an ultrasonic sensor that includes a transmitting section that emits ultrasonic waves and a receiving portion provided facing the transmitting section and sandwiching the paper being transported therebetween. Further, it is also possible to use a lever type sensor which detects, optically or electrical contact, the displacement of the mechanical lever moved by the contact with the paper being transported.

### Image Reading Unit

Hereinafter, the image reading unit 10 will be described. As described above, the image reading unit 10 includes a lower side reading unit 20 disposed at a lower side the transport path S, and an upper side reading unit 30 disposed at an upper side of the transport path S (FIGS. 2 and 3).

As shown in FIG. 3, the first transmission plate 21 of the lower side reading unit 20 forms a path surface S1 on one side of the transport path S, and the second transmission plate 31 of the upper side reading unit 30 forms a path surface S2 on the other side of the transport path S that faces the first transmission plate 21.

The first transmission plate 21 and the second transmission plate 31 may be formed of a colorless transparent glass or a resin plate such as a colorless transparent acrylic plate.

In the lower side reading unit 20 shown in FIG. 4, a first reading unit 22 is provided. The first reading unit 22 has a first upstream side light source 23 which emits light from the upstream side in the medium transport direction to the first reading region A1 of the transport path S, and a first downstream side light source 24 which emits the light from the downstream side in the medium transport direction to the first reading region A1, and reads an image on the first surface (P1 in FIG. 4) of paper P in the first reading region A1 through the first transmission plate 21.

In the present embodiment, the first reading unit 22 and the second reading unit 32 are configured as a contact image sensor module (CISM) as an example.

The first reading unit 22 includes a first lens portion 25 and a first sensor portion 26, which are provided at positions facing the first reading region A1.

Similarly, the second reading unit 32 is provided in the upper side reading unit 30 shown in FIG. 4. As shown in FIG. 4, the second reading unit 32 has a second upstream side light source 33 which emits light from the upstream side in the medium transport direction to the second reading region A2 of the transport path S, and a second downstream side light source 34 which emits light from the downstream side in the medium transport direction to the second reading region A2, and reads an image on the second surface of paper P (P2 in FIG. 4) in the second reading region A2 through the second transmission plate 31.

The second reading unit 32 includes a second lens portion 35 and a second sensor portion 36, which are provided at positions facing the second reading region A2.

In addition, on the opposite side to the surface forming the transport path S in the first transmission plate 21 shown in FIG. 4, light blocking plate 27 is provided at a position excluding the region through which the lights of the first upstream side light source 23 and the first downstream side light source 24 pass in the medium transport direction, and the region in which the second reading unit 32 overlaps with the second reading region A2, and a reference plate 28 is provided in a region in which the second reading unit 32 overlaps with the second reading region A2.

Similarly, on the opposite side of the surface forming the transport path S in the second transmission plate 31 shown in FIG. 4, light blocking plate 37 is provided at a position excluding the region through which the lights from the second upstream side light source 33 and the second downstream side light source 34 pass in the medium transport direction, and the region in which the first reading unit 22 overlaps with the first reading region A1, and a reference plate 38 is provided in a region in which the first reading unit 22 overlaps the first reading region A1.

A reference plate 28 and a reference plate 38 are white and serve as a reference for calibration in the second reading unit 32 and the first reading unit 22.

A first transmission plate 21 and a second transmission plate 31 are provided at an area overlapping both with the second reading unit 32 and the first reading unit 22 in the medium transport direction.

The amount of light emitted from the first upstream side light source 23, the first downstream side light source 24, the second upstream side light source 33, and the second downstream side light source 34 is controlled by a control unit 19 (FIGS. 2 and 3) provided in the apparatus main body 2.

As shown in FIG. 5, when the leading end of the paper P is read by the first reading unit 22 in the first reading region A1, and there is no paper P in the second reading region A2, the light emitted from the second downstream side light source 34 of the two light sources provided in the second reading unit 32 may reach the first reading region A1. For example, the emitted light L2-1 emitted from the second downstream side light source 34 directly reaches the first reading region A1. In addition, the emitted light L2-2 from the second downstream side light source 34 reflects on the first transmission plate 21, and the reflected light R2 reaches the first reading region A1. In FIG. 5, the arrow indicating the light emitted from the light source other than the second downstream side light source 34 is omitted.

When the light (emitted light L2-1, reflected light R2) emitted from the second downstream side light source 34 reaches the first reading region A1, the amount of light in the first reading region A1 is changed, and thus there is a concern that the image reading by the first reading unit 22 may be affected.

In order to avoid this problem, as shown in FIG. 6, when the leading end of the paper P being transported is read by the first reading unit 22 and there is no paper P in the second reading region A2, the control unit 19 suppresses the amount of light emitted from the second downstream side light source 34 below the amount of the light emitted at the time of reading by the second reading unit 32. In FIG. 6, the second downstream side light source 34 shown in black indicates a state where the amount of light is reduced. In the present embodiment, the second downstream side light source 34 is turned off.

More specifically, as shown in FIG. 7, on the upstream side of the second reading region A2 in the medium transport direction, the leading end of the paper P passes the first position B1 where the light emitted from the second downstream side light source 34 may be blocked from entering the first reading region A1, the amount of light emitted from the second downstream side light source 34 is set to the amount of light emitted at the time of reading by the second reading unit 32. In the present embodiment, the second downstream side light source 34 in the turned-off state is changed to turned-on a state. In FIG. 7, the arrow for indicating the light emitted from the light source other than the second downstream side light source 34 is omitted.

In this embodiment, as shown in FIG. 7, the first position B1 is where both of the emitted light L2-1 and emitted light L2-2 may be blocked by paper P, when the leading end of paper P at that position.

When the emitted light L2-1 is blocked by paper P, the emitted light L2-1 can be restrained from directly entering the first reading region A1. In addition, when the emitted light L2-2 is blocked by paper P, since the emitted light L2-2 does not reflect on the first transmission plate 21, the reflected light R2 (FIG. 5) can be restrained from entering the first reading region A1.

For example, according to the angle of the optical axis from the second downstream side light source 34, for example, among the lights emitted from the second downstream side light source 34, the emitted light L2-1 may directly enter the first reading region A1, while the reflected light may not enter the first reading region A1 in some cases. Further, this may be applies in reverse in some cases. In such a case, the first position B1 may be set so that paper blocks only the light that may enter the first reading region A1.

That is, the control unit 19 suppresses the amount of light emitted from the second downstream side light source 34 below the amount of light emitted at the time of reading by the second reading unit 32, until the leading end of the paper P being transported reaches the first position B1 where the light emitted from the second downstream side light source 34 may be blocked from entering the first reading region A1, and when the leading end of the paper P passes the first position B1, the control unit sets the amount of light emitted from the second downstream side light source 34 to the amount of light emitted at the time of reading by the second reading unit 32.

By this, it is possible to relieve the concern that the light emitted from the second downstream side light source 34 affects reading by the first reading unit 22.

Meanwhile, when the light is intensified after weakening of the light by reducing the amount of light from the light source, the amount of light may become unstable for a short time. As in the related art, when all the light source of the second reading unit 32, that is, both of the second upstream side light source 33 and the second downstream side light source 34 are turned off, and then the second upstream side light source 33 and the second downstream side light source 34 are turned on immediately before the reading by the second reading unit 32 is started, the state in which the amount of light is unstable immediately after intensifying the light may greatly affect image reading by the second reading unit 32.

In the present embodiment, the second downstream side light source 34 is turned on immediately before the reading by the second reading unit 32 is started, however, among the two light sources (second upstream side light source 33 and second downstream side light source 34) of the second reading unit 32, only the amount of light of the second downstream side light source 34 is reduced, which is facing the first reading unit 22 side and is likely to affect the reading in the first reading unit 22, thereby reducing the concern that a state where the amount of light is unstable immediately after intensifying light affects the reading at the time of reading by the second reading unit 32.

Subsequently, as soon as the leading end of paper P passes the first position B1, the leading end of paper P reaches the second reading region A2 of second reading unit 32, and reading by second reading unit 32 is started. As shown in FIG. 8, as the reading of paper P continues such that when only the trailing end of paper P can be read by second reading unit 32, paper P has passed completely away from the first reading region A1. At this time, the light emitted from the first upstream side light source 23 of the two light sources provided in the first reading unit 22 may reach the second reading region A2. For example, as shown in FIG. 8, the emitted light L1-1 emitted from the first upstream side light source 23 directly reaches the second reading region A2. In addition, the emitted light L1-2 emitted from the first upstream side light source 23 reflects on the second transmission plate 31, and the reflected light R1 reaches the second reading region A2. In FIGS. 8 and 9, the description of the arrow indicating the light emitted from the light source other than the first upstream side light source 23 is omitted.

When the light (emitted light L1-1, reflected light R1) emitted from the first upstream side light source 23 reaches the second reading region A2, the amount of light in the second reading region A2 is changed which causes a concern that the image reading by the second reading unit 32 is affected.

In order to avoid this problem, on the upstream side of the second reading region A2 in the medium transport direction, the control unit 19 suppresses the amount of light emitted from the first upstream side light source 23 to the amount of light emitted at the time of reading by the first reading unit 22, as shown in FIG. 10, when the trailing end of the paper P being transported passes the second position B2 (FIG. 9) where the light emitted from the first upstream side light source 23 may be blocked from entering the second reading region A2.

In this embodiment, as shown in FIG. 9, the second position B2 is a position where both the emitted light L1-1 and the emitted light L1-2 may be blocked by paper P when the trailing end of paper P at that position. If the emitted light L1-1 is blocked by paper P, it is possible to restrain the emitted light L1-1 from directly entering the second reading region A2. In addition, when the emitted light L1-2 is blocked by paper P, the emitted light L1-2 does not reflect on the second transmission plate 31, thereby suppressing the reflected light R1 (FIG. 8) from entering the second reading region A2.

For example, according to the angle of the optical axis from the first upstream side light source 23, for example, among the lights emitted from the first upstream side light source 23, the emitted light L1-1 may directly enter the second reading region A2, while reflected light may not enter the second reading region A2 in some cases. Further, this may be applied in reverse in some cases. In such a case, the second position B2 may be set so that the paper blocks only the light that may enter the second reading region A2.

In FIG. 10, the first upstream side light source 23 shown in black indicates a state where the amount of light is reduced. In this embodiment, the first upstream side light source 23 is turned off.

By this, it is possible to relieve the concern that the light emitted from the first upstream side light source 23 affects the image reading by the second reading unit 32.

After completion of the reading of the trailing end of the paper P by the second reading unit 32, and before paper P to be read next is transported to first reading region A1 where the reading by first reading unit 22 is performed, the first upstream side light source 23 is set to the amount of light emitted at the time of reading by the first reading region A1.

When determining the timing at which the control unit 19 suppresses the amount of light of each light source, based on the position of the leading end or the trailing end of paper P, the position of the leading end of the paper P may be obtained by, for example, the detection information of the leading end of paper P in the third detecting unit 42 provided between the first transport roller pair 16 and the image reading unit 10 and the transported amount by the first transport roller pair 16.

In addition, the position of the trailing end of the paper P may be obtained by the detection information of the trailing end of the paper P in the third detecting unit 42 and the amount of transport by the second transport roller pair 17. Alternatively, the position of the trailing end of the paper P may be obtained based on the detection information of the leading end of paper P in the fourth detecting unit 43 provided on the downstream side of the second transport roller pair 17.

### Second Embodiment

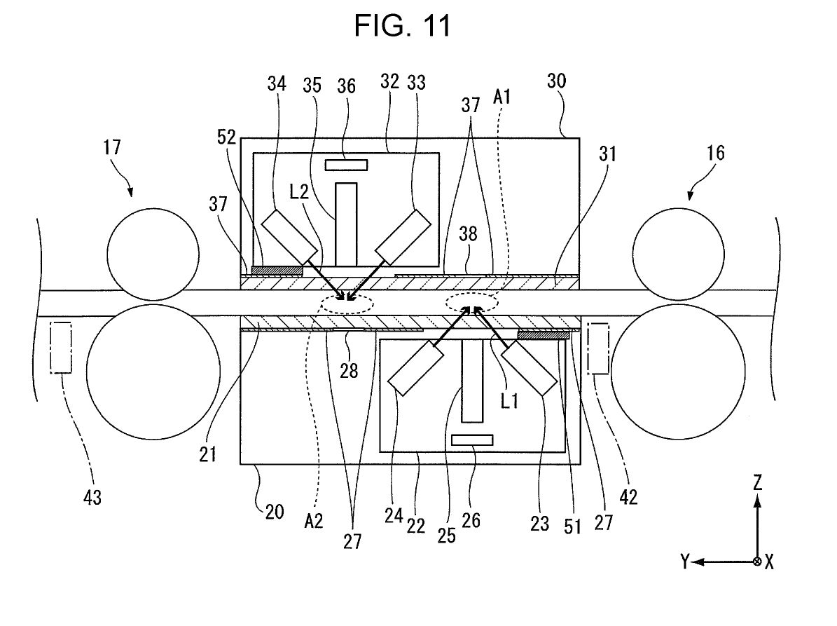

In the second embodiment, another example of the image reading apparatus according to this invention will be described with reference to FIGS. 11 to 16.

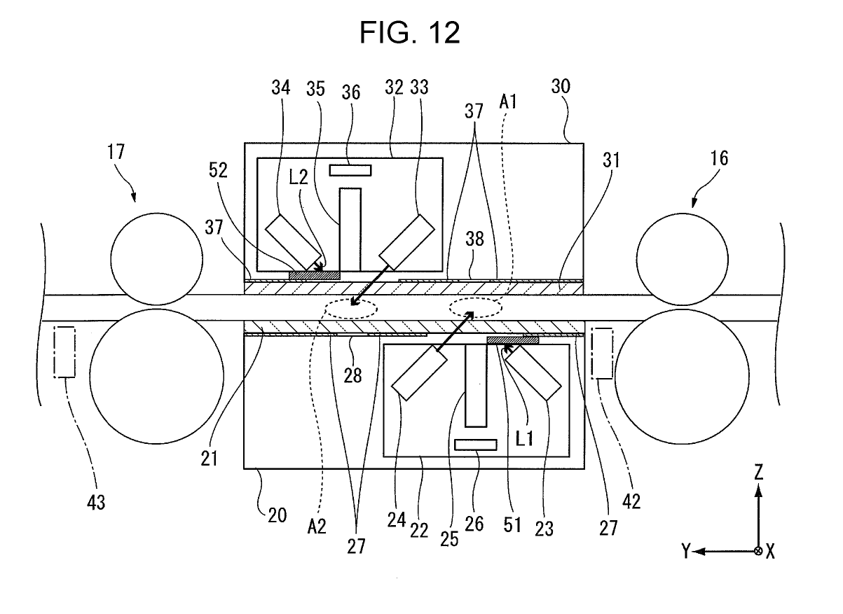

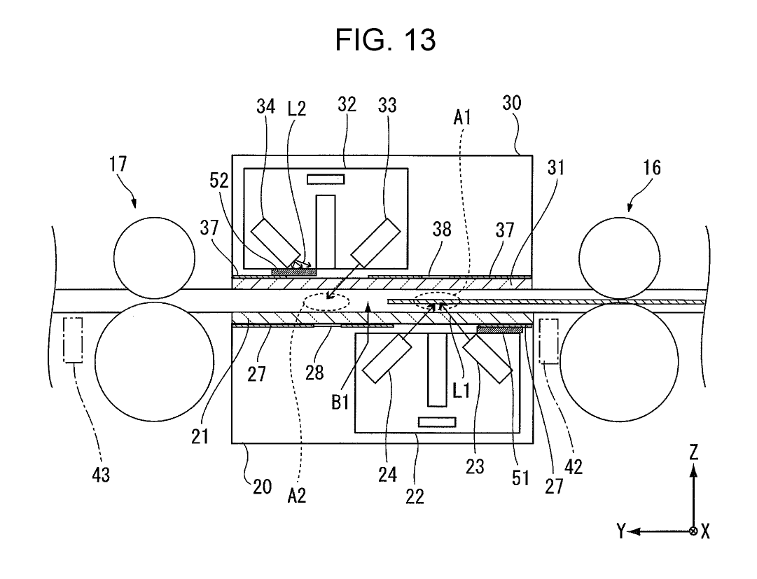

FIG. 11 is a view illustrating the opened state of the first shutter portion and the second shutter portion according to the second embodiment. FIG. 12 is a view illustrating the blocked state of the first shutter portion and the second shutter portion according to the second embodiment. FIGS. 13 to 16 are views explaining with respect to the control of the first shutter portion and the second shutter portion by the control unit.

Further, in the embodiments that will follow the present embodiment, the same reference numerals are given to the same components as those of the first embodiment, and the description thereof will be not repeated.

In the second embodiment, the lower side reading unit 20 is provided with a first shutter portion 51 capable of switching between a blocked state (FIG. 12) in which the light emitted from the first upstream side light source 23 to the first reading region A1 is blocked, and an opened state (FIG. 11) in which the light emitted from the first upstream side light source 23 reaches the first reading region A1.

In addition, the upper side reading unit 30 is provided with a second shutter portion 52 capable of switching between the blocked state (FIG. 12) in which the light emitted from the second downstream side light source 34 to the second reading region A2 is blocked, and an opened state (FIG. 11) in which the light emitted from the second downstream side light source 34 reaches the second reading region A2.

The first shutter portion 51 and the second shutter portion 52 are configured to be able to slide to switch between the blocked state and the opened state by receiving power received from a power source such as a motor.

Switching between the blocked state and the opened state of the first shutter portion 51 and the second shutter portion 52 is controlled by the control unit 19.

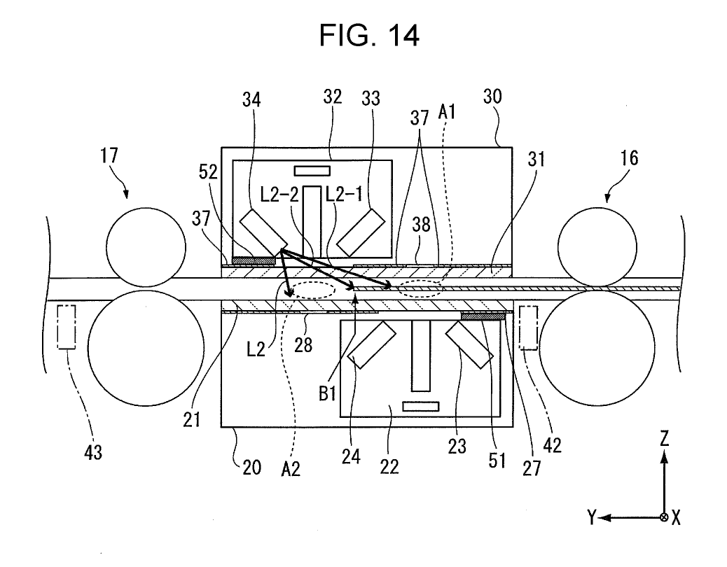

In this embodiment, as shown in FIG. 13, the control unit 19 sets the second shutter portion 52 as the blocked state until the leading end of the paper P being transported is transported to the first position B1 (FIG. 14) where the light emitted from the second downstream side light source 34 may be blocked from entering the first reading region A1 on the upstream side of the second reading region A2 in the medium transport direction, and as shown in FIG. 14, when the leading end of the paper P passes the first position B1, the control unit 19 sets the second shutter portion 52 to the opened state.

By this, until the leading end of paper P reaches the first position B1 in the medium transport direction, it is possible to relieve the concern that the light emitted from the second downstream side light source 34 (the emitted light L2-1 which directly enters the first reading region A1 or the reflected light (not shown in FIG. 14) which is the emitted light L2-2 reflecting on the first transmission plate 21) affects the reading by the first reading unit 22. In addition, in FIG. 14, the description of the arrow indicating the light emitted from the light source other than the second downstream side light source 34 is omitted.

In addition, in this embodiment, as shown in FIG. 13, since the emitted light L2 of the second downstream side light source 34 is blocked by the second shutter portion 52, there is no need to reduce the amount of light of the second downstream side light source 34. Therefore, there is no concern that the amount of light of the second downstream side light source 34 may not be stabilized when the amount of light is increased from the state in which the amount of light is reduced. Therefore, a stable image reading by the second reading unit 32 can be realized.

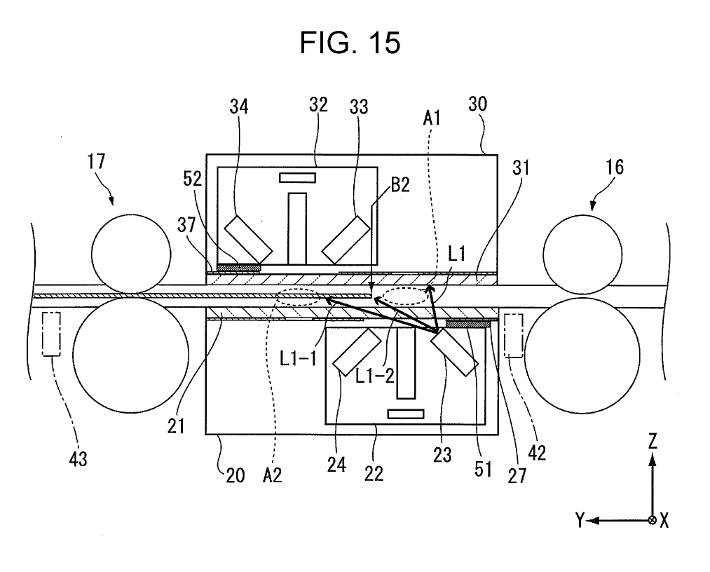

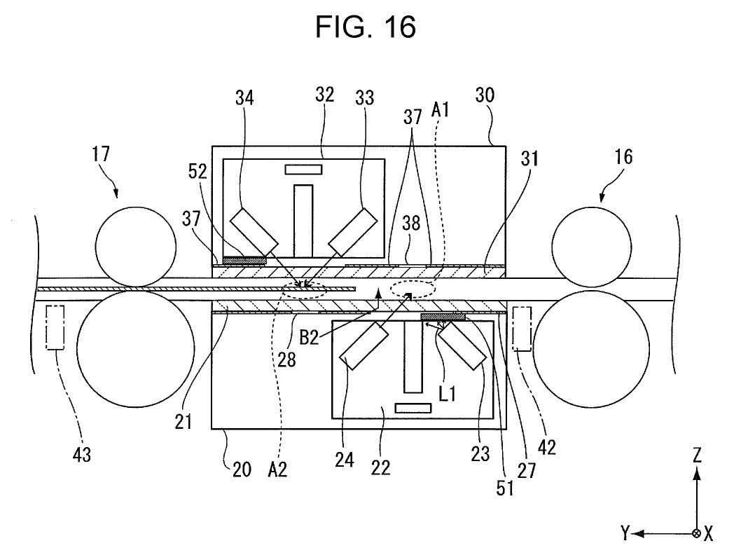

Furthermore, as shown in FIG. 15, on the upstream side of the second reading region A2 in the medium transport direction, the control unit 19 sets the first shutter portion 51 as the opened state until the second position B2 until the trailing end of the paper P being transported reaches the second position B2 where light emitted from first upstream side light source 23 may be blocked from entering the second reading region A2, and as shown in FIG. 16, the control unit 19 sets the first shutter portion 51 to the blocked state when it passes the second position B2.

In addition, in FIG. 15, the description of the arrow indicating the light emitted from the light source other than the first upstream side light source 23 is omitted.

By this, it is possible to relieve the concern that the light emitted from the first upstream side light source 23 (the emitted light L1-1 which directly enters the second reading region A2 or the reflected light (not shown in FIG. 15) which is the emitted light L1-2 reflects on the second transmission plate 31) affecting the image reading by the second reading unit 32.

In addition, since the emitted light L1 from the first upstream side light source 23 is blocked by the first shutter portion 51, there is no need to reduce the amount of light of the first upstream side light source 23. Therefore, there is no concern that the amount of light of the first upstream side light source 23 may not be stabilized when the amount of light is increased from the state in which the amount of light is reduced. Therefore, a stable image reading by the first reading unit 22 can be realized.

### Third Embodiment

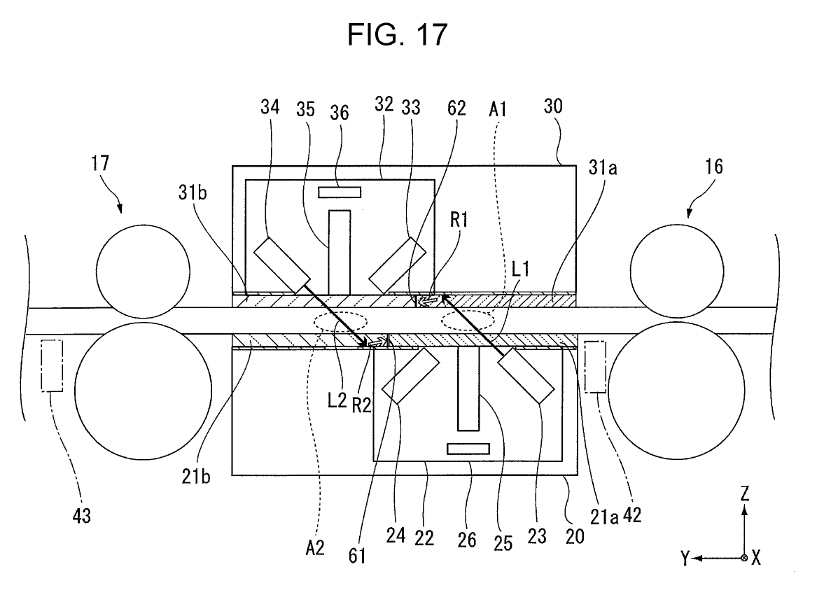

In the third embodiment, still another example of the image reading apparatus according to this invention will be described with reference to FIGS. 17 to 20.

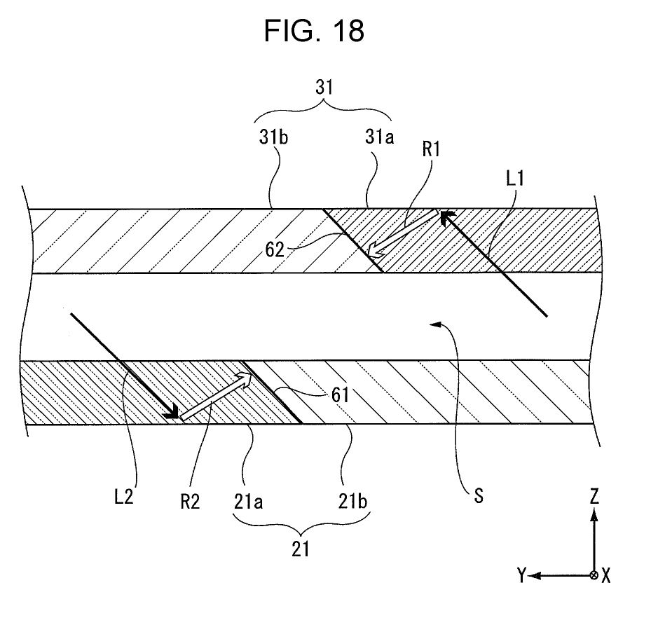

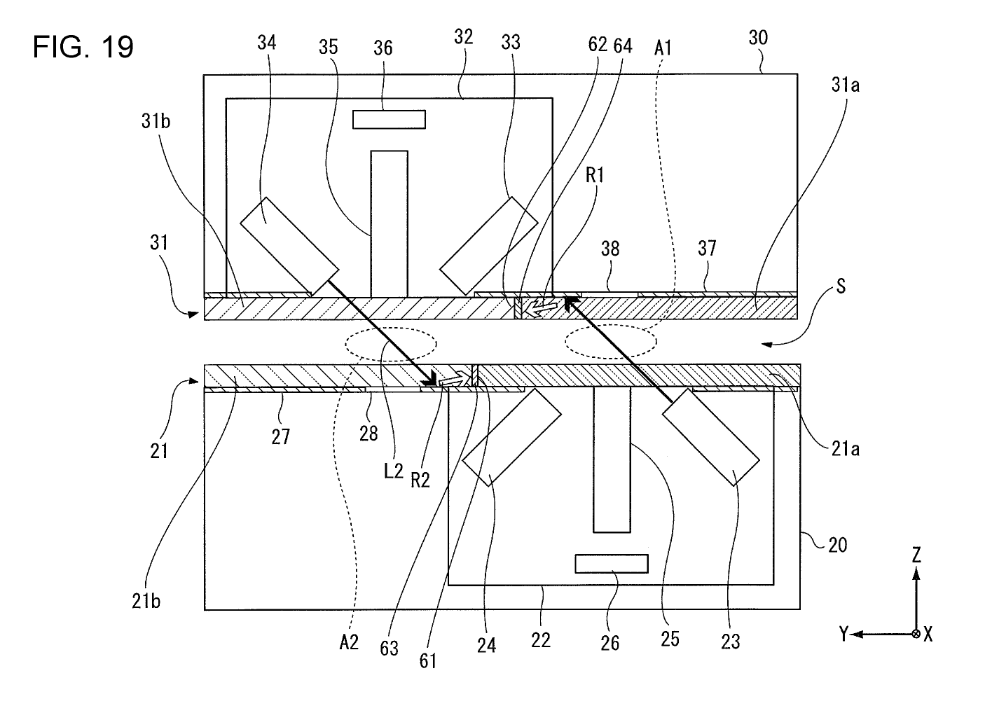

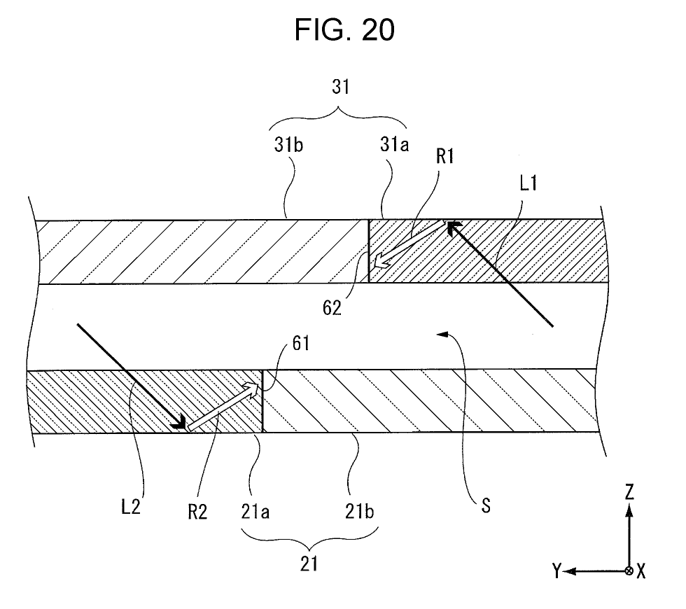

FIG. 17 is a schematic cross-sectional side view illustrating the image reading unit in the scanner according to the third embodiment. FIG. 18 is a view for explaining Modification Example 1 of the third embodiment. FIG. 19 is a view for explaining Modification Example 2 of the third embodiment. FIG. 20 is a view for explaining Modification Example 3 of the third embodiment.

In the third embodiment, the first transmission plate 21 includes a first seam 61 as a “first reflection suppression unit” which suppresses the reflection of emitted light L2 emitted from the second downstream side light source 34 as shown in FIG. 17, and the second transmission plate 31 includes a second seam 62 as a “second reflection suppression unit” which suppresses the reflection of the emitted light L1 emitted from the first upstream side light source 23.

The first seam 61 is formed when the first transmission plate 21, that is, two transmission plates 21a and 21b are formed by connecting side by side in the medium transport direction. In addition, the second seam 62 is formed when the second transmission plate 31, that is, two transmission plates 31a and 31b are formed by connecting side by side in the medium transport direction. The “first reflection suppression unit” and “second reflection suppression unit” can be easily formed by the seam of two transmission plates.

Further, the two transmission plates 21a and 21b or the two transmission plates 31a and 31b may be arranged with a slight gap therebetween without completely contacting each other at the first seam 61 or the second seam 62.

The first seam 61 of the first transmission plate 21 blocks the reflected light R2 of the emitted light L2 emitted from the second downstream side light source 34 and restrains the reflected light R2 from reaching the first reading region A1 of the first reading unit 22, thereby relieving the concern that the reflected light R2 affects the image reading of the first reading unit 22.

In addition, the second seam 62 of the second transmission plate 31 blocks the reflected light R1 of the emitted light L1 emitted from the first upstream side light source 23 and restrains the reflected light R1 from reaching the second reading region A2 of the second reading unit 32, thereby relieving the concern that the reflected light R1 affects the image reading of the second reading unit 32.

### Modification Example 1 of Third Embodiment

In FIG. 17, a paint that reduces light transmitting property may be applied on the first seam 61 and the second seam 62. For example, a deep color paint such as black paint may be applied.

By this, suppression of the reflected light R2 in the first seam 61, and suppression of reflected light R1 in the second seam 62 may be ensured more reliably. In addition, processing of vitrifying the first seam 61 and the second seam 62 may be performed.

### Modification Example 2 of Third Embodiment

In addition, as shown in FIG. 18, the first seam 61 and the second seam 62 may be formed to be inclined with respect to the surface of the first transmission plate 21 or the second transmission plate 31 when viewed from the width direction (X axis direction) intersecting the medium transport direction (+Y direction).

By this, it is possible to widen the cross-sectional area of the first seam 61 that blocks the reflected light R2 and the second seam 62 that blocks the reflected light R1, thereby more reliably suppressing light reflection.

In addition, as shown in FIG. 18, the first seam 61 and the second seam 62 may be inclined downward along the medium transport direction, in addition to the case of inclining upward along the medium transport direction. In that case, it is preferable that the first seam 61 is provided at a position that blocks the emitted light L2 emitted from the second downstream side light source 34, and the second seam 62 is provided at the position that blocks the emitted light L1 emitted from the first upstream side light source 23.

### Modification Example 3 of Third Embodiment

In addition, as shown in FIG. 19, the first seam 61 and the second seam 62 may be configured to have blocking plates 63 and 64 therebetween, that suppresses light transmission, respectively. The blocking plates 63, 64 may be formed of, for example, opaque or resin material that has a low light transmitting property.

By this, it is possible to more reliably suppress the reflected light in the first seam 61 and the second seam 62.

### Modification Example 4 of Third Embodiment

In addition, in FIG. 20, the transmission plate 21a and the transmission plate 21b constituting the first transmission plate 21 use transmission plates that have different refractive indices. Two transmission plates 31a and 31b constituting the second transmission plate 31 also use transmission plates that have different refractive indices.

That is, the refractive indices of the two transmission plates constituting the first transmission plate 21 or the second transmission plate 31 are different from each other.

By this, it is possible to more reliably suppress the reflection of light in the first seam 61 and the second seam.

In addition, the transmission plate 21b (see also FIG. 17) facing the first reading unit 22 in the lower side reading unit 20, and the transmission plate 31b facing the second reading unit 32 in the upper side reading unit 30 preferably have the same refractive index.

### Fourth Embodiment

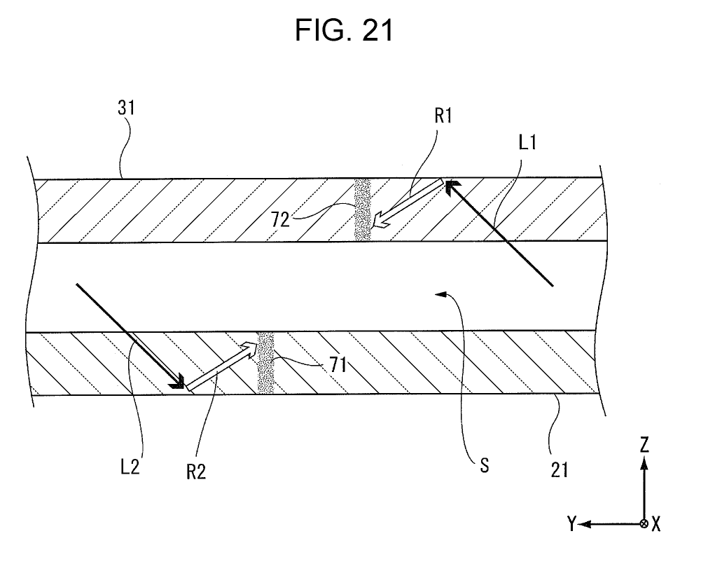

In the fourth embodiment, still another example of the image reading apparatus according to the invention will be described with reference to FIG. 21. FIG. 21 is a schematic side view illustrating a first transmission plate and a second transmission plate of an image reading unit according to a fourth embodiment.

In the fourth embodiment, the “first reflection suppression unit” and “second reflection suppression unit” described in the third embodiment are formed by laser engraving in the first transmission plate 21 or the second transmission plate 31. The first reflection suppression unit 71 and the second reflection suppression unit 72 shown in FIG. 21 are formed by laser engraving (etching) so that the first transmission plate 21 and the second transmission plate 31 are partially translucent state.

In FIG. 21, the first reflection suppression unit 71 provided in the first transmission plate 21, and the second reflection suppression unit 72 provided in the second transmission plate 31 are provided at positions corresponding to the seam 61 in the first transmission plate 21 and the seam 62 in the second transmission plate 31 of the third embodiment shown in FIG. 17.

The first reflection suppression unit 71 and the second reflection suppression unit 72 may be formed by laser engraving on the first transmission plate 21 and the second transmission plate 31, thereby forming a reflection suppression unit without dividing the transmission plate into two.

### Another Example of First Reflection Suppression Unit and Second Reflection Suppression Unit

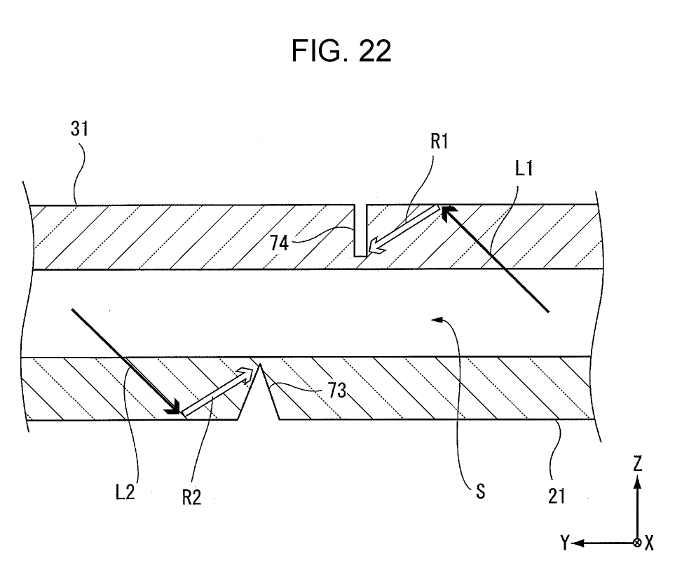

FIG. 22 is a view for explaining another example of the first transmission plate and the second transmission plate.

As shown in FIG. 22, “first reflection suppression unit” and “second reflection suppression unit” may also be formed as notches 73, 74 without dividing the first transmission plate 21 and the second transmission plate 31.

By forming the “first reflection suppression unit” and “second reflection suppression unit” as notches 73, 74, it is possible to form a reflection suppression unit without dividing the transmission plate into two.

In addition, the notch may be provided as an I-shaped slit like the notch 74, in addition to the case of providing a notch in a V shape like the notch 73. The notched part may be filled with a resin material or the like that suppresses transmission of light, for example.

Further, by partially changing the refractive index of one transmission plate, it is possible to form “first reflection suppression unit” and “second reflection suppression unit”. For example, by partially heating the transmission plate, it is possible to change the refractive index of the corresponding portion.

Also, in this case, the reflection suppression unit may be formed without dividing the transmission plate into two.

It is also possible to provide “first reflection suppression unit” and “second reflection suppression unit” of the third embodiment or the fourth embodiment in the first transmission plate 21 and the second transmission plate 31 of the first embodiment or the second embodiment.

Besides, this invention is not limited to the above embodiments, and various modifications are possible within the scope of the invention described in the claims, and it goes without saying that these inventions are also included within the scope of this disclosure.

The entire disclosure of Japanese Patent Application No. 2017-228727, filed Nov. 29, 2017 is expressly incorporated by reference herein.

What is claimed is:

1. An image reading apparatus comprising:
a transport path on which a medium is transported;
a first transmission plate that has light transmitting property and forms a path surface on one side of the transport path;
a second transmission plate that has the light transmitting property and forms a path surface on the other side of the transport path facing the first transmission plate;
a first reading unit that includes a first upstream side light source which emits light from an upstream side in a medium transport direction to a first reading region of the transport path and a first downstream side light source which emits light from a downstream side in the medium transport direction to the first reading region, and reads an image on a first surface of the medium in the first reading region through the first transmission plate;
a second reading unit that includes a second upstream side light source which emits light from the upstream side in the medium transport direction to a second reading region positioned on a downstream side of the first reading region of the transport path in the medium transport direction and a second downstream side light source which emits light from the downstream side in the medium transport direction to the second reading region, and reads an image on a second surface of the medium which is a surface opposite to the first surface in the second reading region through the second transmission plate; and
a control unit that controls an amount of the light emitted from the first upstream side light source, the first downstream side light source, the second upstream side light source, and the second downstream side light source,
wherein the first transmission plate and the second transmission plate are provided at a position overlapping with both the first reading unit and the second reading unit, in the medium transport direction, and
wherein the control unit suppresses the amount of light emitted from the second downstream side light source below the amount of light emitted at the time of reading by the second reading unit until a leading end of the medium being transported is transported to a first position where the light emitted from the second downstream side light source is blocked from entering the first reading region, on an upstream side of the second reading region in the medium transport direction, and when the leading end of the medium passes the first position, sets the amount of light emitted from the second downstream side light source to an amount of light emitted at the time of reading by the second reading unit.

2. The image reading apparatus according to claim 1,
wherein the control unit suppresses the amount of light emitted from the first upstream side light source below the amount of light emitted at the time of reading by the first reading unit on an upstream side of the second reading region in the medium transport direction, when a trailing end of the medium being transported passes a second position where the light emitted from the first upstream side light source is blocked from entering the second reading region.

3. An image reading apparatus comprising:
a transport path on which a medium is transported;
a first transmission plate that has light transmitting property and forms a path surface on one side of the transport path;
a second transmission plate that has light transmitting property and forms a path surface on the other side of the transport path facing the first transmission plate;
a first reading unit that includes a first upstream side light source which emits light from an upstream side in a medium transport direction to the first reading region of the transport path and a first downstream side light source which emits light from the downstream side in a medium transport direction to the first reading region, and reads an image on the first surface of the medium in the first reading region through the first transmission plate; and
a second reading unit that includes a second upstream side light source which emits light from the upstream side in the medium transport direction to a second reading region positioned on the downstream side of the first reading region of the transport path in the medium transport direction and a second downstream side light source which emits light from the downstream side in the medium transport direction to the second reading region and reads an image on a second surface which is a surface opposite to the first surface of a medium in the second reading region through the second transmission plate,
wherein the first transmission plate and the second transmission plate are provided at a position overlapping with both the first reading unit and the second reading unit, in the medium transport direction,
wherein the apparatus further comprises
a first shutter portion capable of switching between a blocked state in which light emitted from the first upstream side light source to the first reading region is blocked, and an opened state in which the light emitted from the first upstream side light source reaches the first reading region;
a second shutter portion capable of switching between a blocked state in which light emitted from the second downstream side light source to the second reading region is blocked, and an opened state in which the light emitted from the second downstream side light source reaches the second reading region; and
a control unit which controls switching between the blocked state and the opened state of the first shutter portion and the second shutter portion, and
wherein the control unit sets the second shutter portion as the blocked state until the leading end of the medium being transported is transported to the first position where the light emitted from the second downstream side light source is blocked from entering the first reading region, on an upstream side of the second reading region in the medium transport direction, and when the leading end of the medium passes the first position, sets the second shutter portion to the opened state.

4. The image reading apparatus according to claim 3,
wherein the control unit sets the first shutter portion as the blocked state when the trailing end of the medium being transported passes the second position where the light emitted from the first upstream side light source is blocked from entering the second reading region, on the upstream side of the second reading region in the medium transport direction.

5. An image reading apparatus comprising:
a transport path on which a medium is transported;
a first transmission plate that has light transmitting property and forms a path surface on one side of the transport path;
a second transmission plate that has the light transmitting property and forms a path surface on the other side of the transport path facing the first transmission plate;
a first reading unit that includes a first upstream side light source which emits light from the upstream side in the medium transport direction to the first reading region of the transport path and a first downstream side light source which emits the light from the downstream side in the medium transport direction to the first reading region, and reads an image on a first surface of the medium in the first reading region through the first transmission plate; and
a second reading unit that includes a second upstream side light source which emits the light from the upstream side in the medium transport direction to the second reading region positioned on the downstream side of the first reading region of the transport path in the medium transport direction and a second downstream side light source which emits the light from the downstream side in the medium transport direction to the second reading region, and reads an image on a second surface which is a surface opposite to the first surface of the medium, in the second reading region through the second transmission plate,
wherein the first transmission plate and the second transmission plate are provided at a position overlapping with a position overlapping with both the first reading unit and the second reading unit, in the medium transport direction,
the first transmission plate includes a first reflection suppression unit which suppresses reflection of light emitted from the second downstream side light source, and
the second transmission plate includes a second reflection suppression unit which suppresses reflection of the light emitted from the first upstream side light source.

6. The image reading apparatus according to claim 5,
wherein the first reflection suppression unit or the second reflection suppression unit is a seam when two transmission plates constituting each of the first transmission plate or the second transmission plate are connected side by side in the medium transport direction.

7. The image reading apparatus according to claim 6,
wherein a blocking plate which suppresses the transmission of light is interposed in the seam.

8. The image reading apparatus according to claim 6,
wherein a paint that reduces a light transmitting property is applied on the seam.

9. The image reading apparatus according to claim 6,
wherein the two transmission plates constituting each of the first transmission plate or the second transmission plate have different refractive indices.

10. The image reading apparatus according to claim 5,
wherein the first reflection suppression unit or the second reflection suppression unit is formed on the first transmission plate or the second transmission plate by a laser engraving.

11. The image reading apparatus according to claim 6,
wherein the seam is inclined with respect to a surface of the first transmission plate or the second transmission plate when viewed from a width direction intersecting the medium transport direction.
